(19) United States
(12) Patent Application Publication
(10) Pub. No.: US 2021/0205973 A1
(43) Pub. Date: Jul. 8, 2021

(54) WHEELED ACCESSORY FOR NAIL GUN

(71) Applicant: Christopher Villanueva, Hialeah, FL (US)

(72) Inventor: Christopher Villanueva, Hialeah, FL (US)

(21) Appl. No.: 16/734,149

(22) Filed: Jan. 3, 2020

(51) Int. Cl. B25C 7/00; B27F 7/00

(52) U.S. Cl. CPC B25C 7/00; B27F 7/006

(57) ABSTRACT

A wheeled accessory for a nail gun comprises a frame, at least three wheels coupled to the frame, an axle having two of the at least three wheels at each end of the axle, a mounting point configured to hingedly couple to the nail gun, a cam coupled to the axle, wherein the cam is configured to make sliding contact with the nail gun when the nail gun, and wherein the cam lifts the nail gun when the cam is in a first orientation and the cam lowers the nail gun when the cam is in a second orientation, and a rod coupled to a trigger of the nail gun, wherein the rod is configured to contact the frame when the nail gun is lowered, thereby activating the nail gun, wherein when the wheeled accessory moves forward, the nail gun shoots a nail into the surface at periodic intervals.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to the field of tools and, more specifically, relates to the field of tools related to nail guns and accessories for use with nail guns.

### BACKGROUND

The process of installing or refurbishing a roof for a residential or commercial building can be time consuming and expensive. One of the most labor-intensive portions of a roof installation or roof refurbishment is the application of the roof membrane to the roof. A roof membrane can consist of tar paper or another type of water-impermeable membrane that is configured for secure attachment to a roof and is designed to withstand local weather, temperatures and precipitation. Often, the roof membrane is attached to the roof using nails. One of the drawbacks of the conventional approach to nailing a roof membrane to a roof involves labor and precision.

Nail guns are often used for nailing a roof membrane to a roof. Nail guns for roofing are designed to drive roofing nails into the roof at just the proper depth. Cap nails are usually used to attach the roofing membrane, such as roofing felt, tar paper, etc. to the roof. Unlike galvanized nails, a cap nail has a steel shank and a large polyethylene or metal cap to prevent leaks. The problem associated with the use of nail guns involves the physical requirement that the worker must bend over to apply the nail gun to the roof surface. In situations where large amounts of membrane must be attached to an expansive roof, this physical requirement can be tiresome and lead to physical problems for the laborer. Another problem associated with the use of nail guns involves the precision with which the nails must be applied to the roof surface. Often, there are building code requirements that require a nail be placed at regular defined intervals on the roof. Nails must also be deployed linearly, i.e., along a well-defined line on the roof. It can be difficult for laborers to be precise in placing nails at exactly the right intervals on the roof, and exactly on a well-defined line, especially when fatigue starts to set in.

Therefore, a need exists to overcome the problems with the prior art as discussed above, and particularly for a more efficient and ergonomic way of applying nails to a roof at precisely the correct intervals.

### SUMMARY

A wheeled accessory for a nail gun is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, an article is provided that solves the above-described problems. A wheeled accessory for a nail gun comprises a frame having a top side, a bottom side, a front and a rear end, at least three wheels coupled to the bottom of the frame, an axle having two of the at least three wheels at each end of the axle, the axle being coupled to the bottom of the frame, a mounting point located at the rear end of the frame, the mounting point configured to hingedly couple to the nail gun, such that the nail gun rotates about said mounting point, a cam coupled to a midpoint of the axle, the cam having a projection with a height that varies as the axle rotates, wherein the cam is configured to make sliding contact with the nail gun when the nail gun is mounted to the mounting point, and wherein the cam lifts the nail gun upwards when the cam is in a first orientation and the cam lowers the nail gun downwards when the cam is in a second orientation, and a rod coupled to a trigger of the nail gun, wherein the rod is configured to contact the frame when the nail gun is lowered downwards, thereby activating the nail gun, wherein when the wheeled accessory moves forward on a surface, the axle rotates the cam, which moves the nail gun upwards and subsequently downwards, and the nail gun shoots a nail into the surface at periodic intervals.

### BRIEF DESCRIPTION OF THE DRAWINGS

The accompanying drawings, which are incorporated in and constitute a part of this disclosure, illustrate various example embodiments. In the drawings:

FIG. 1A depicts a right-side view of a wheeled accessory for a nail gun in the up position, according to an example embodiment.

FIG. 1B depicts a right-side view of a wheeled accessory for a nail gun in the up position, showing certain components in a cross-sectional view, according to an example embodiment.

FIG. 2A depicts a right-side view of the wheeled accessory for the nail gun in the down position, according to an example embodiment.

FIG. 2B depicts a right-side view of the wheeled accessory for the nail gun in the down position, showing certain components in a cross-sectional view, according to an example embodiment.

FIG. 3 depicts a right-side perspective view of the wheeled accessory for the nail gun in the down position, according to an example embodiment.

FIG. 4 depicts a top perspective view of the wheeled accessory for the nail gun in the down position, according to an example embodiment.

FIG. 5 depicts a top view of the wheeled accessory for the nail gun, according to an example embodiment.

FIG. 6 depicts a bottom view of the wheeled accessory for the nail gun, according to an example embodiment.

FIG. 7 depicts an exploded view of the wheeled accessory for the nail gun, according to an example embodiment.

FIG. 8 depicts views of the cam of the wheeled accessory for the nail gun, according to an example embodiment.

### DETAILED DESCRIPTION

The following detailed description refers to the accompanying drawings. Wherever possible, the same reference numbers are used in the drawings and the following description to refer to the same or similar elements. While embodiments of the claimed subject matter may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed subject matter improves over the prior art by providing an apparatus that is efficiently designed and allows workers to easily deploy nails or cap nails onto a roof linearly and at periodic intervals with great precisions. The claimed subject matter presents an inexpensively manufactured apparatus that can easily deployed and utilized on a roof or any other surface where the installation of nails linearly and at a periodic interval is necessary. This feature increases the usability of nail guns for installing nails. Further, the claimed subject matter reduces fatigue by workers, as they are not required to be hunched over or bent over during use of the device when deploying nails. This feature of the claimed subject matter facilitates situations where laborers must be precise in placing nails at exactly the right intervals on the roof, and exactly on a well-defined line.

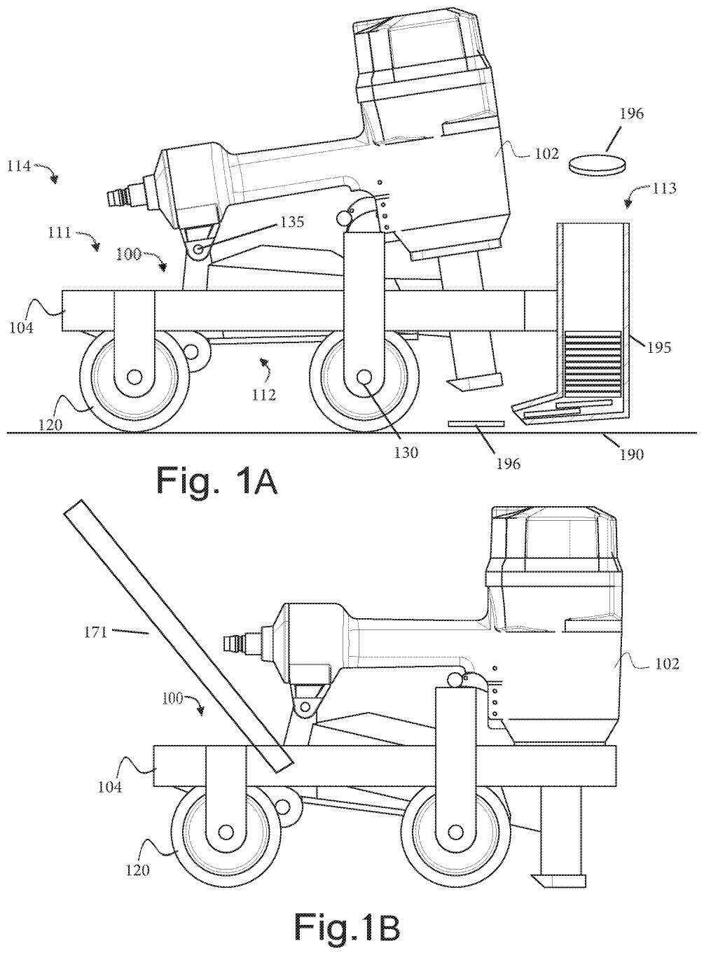

The accompanying drawings, which are incorporated in and constitute a part of this disclosure, illustrate various example embodiments. The claimed wheeled accessory will now be described with respect to FIGS. 1 through 7. FIG. 1A depicts a right-side view of a wheeled accessory 100 for a nail gun 102 in the up position, according to an example embodiment. FIG. 1A shows that the wheeled accessory 100 includes a frame 104 having a top side 111, a bottom side 112, a front end 113 and a rear end 114. FIG. 1A further shows that the wheeled accessory 100 includes wheels 120 coupled to the bottom side 112 of the frame 104. FIG. 1A further shows that the wheeled accessory 100 includes an axle 130 having wheels 120 at each end of the axle, the axle 130 being coupled to the bottom side 112 of the frame 104.

FIG. 1A further shows that the wheeled accessory 100 includes a mounting point 135 located at the rear end 114 of the frame 104, the mounting point 135 configured to hingedly couple to the nail gun 102, such that the nail gun rotates about said mounting point. The wheeled accessory 100 includes a cam 140 coupled to a midpoint of the axle 130, the cam having a projection 141 with a height that varies as the axle 130 rotates, wherein the cam 140 is configured to make sliding contact with the nail gun 102 when the nail gun is mounted to the mounting point 135, and wherein the cam 140 lifts the nail gun 102 upwards when the cam is in a first orientation and the cam 140 lowers the nail gun 102 downwards when the cam is in a second orientation. FIG. 1A shows that the cam 140 is in the first orientation since the cam has lifted the nail gun 102 upwards into the up position.

FIG. 1A further shows that the wheeled accessory 100 includes a rod 150 coupled to a trigger 152 of the nail gun 102, wherein the rod 150 is configured to contact the frame 104 when the nail gun 102 is lowered downwards, thereby activating the nail gun so as to shoot or deploy a nail into the surface 190. As the wheeled accessory 100 moves forward on the surface 190, the axle 130 rotates the cam 140, which moves the nail gun 120 upwards and subsequently downwards, and the nail gun 102 shoots a nail into the surface 190 at periodic intervals.

FIG. 1A further shows a cap dispenser 195 in cross sectional view. The cap dispenser 195 is a device that holds a plurality of caps 196 in stacked form in a container that having a volume required for holding a predefined number of caps, for example, one hundred caps. A cap nail is a nail that comprises a nail and a cap having the form of a circular disc. The nail is driven through the center of the cap and the nail is further driven into the roof surface. The purpose of the cap is to secure the orifice made by the nail in the roof surface, so as to prevent leakage of liquid through the orifice. The cap dispenser 195 holds a plurality of caps 196 in its container and then dispenses a single cap onto the roof surface in the exact position that a nail will be driven into the roof surface. That is, the cap dispenser 195 deploys a cap 196 directly underneath the nail as the nail is being driven into the roof surface by the nail gun 102. The cap dispenser 195 has a means for dispensing a single cap onto the roof surface in the exact position that a nail will be driven into the roof surface. Said means may include a servo that activates a lever that pushes a cap out of the dispenser 195 and onto the roof surface at a periodic interval that matches the interval at which nails are deployed by the nail gun 102 onto the roof surface.

FIG. 1B depicts a right-side view of a wheeled accessory 100 for a nail gun 102 in the up position, showing certain components in a cross-sectional view, according to an example embodiment. FIG. 1B shows that the wheeled accessory 100 includes a mounting point 135 located at the rear end 114 of the frame 104, the mounting point 135 configured to hingedly couple to the nail gun 102, such that the nail gun rotates about said mounting point. FIG. 1B shows that the nail gun 102 has been lifted upwards into the up position such that the nail gun has rotated about the mounting point such that the working end of the nail gun has been lifted off of the surface of the roof.

Cam 140 is coupled to a midpoint of the axle 130, the cam having a projection 141 with a height that varies as the axle 130 rotates, wherein the cam 140 is configured to make sliding contact with the nail gun 102, and wherein the cam 140 has lifted the nail gun 102 upwards because the cam is in a first orientation. In FIG. 1A, the cam 140 is in the first orientation since the cam has lifted the nail gun 102 upwards into the up position.

In one embodiment, the mounting point 135 comprises a fulcrum upon which a portion of the nail gun 102 rests, wherein the nail gun rotates about said fulcrum when the nail gun is moved upwards by the cam 140. A fulcrum is the point on which a lever rests or is supported and on which it pivots. The mounting point 135 can be a hinged attachment or a portion of the nail gun 102 may simply rest on the mounting point without any attachment or hinge.

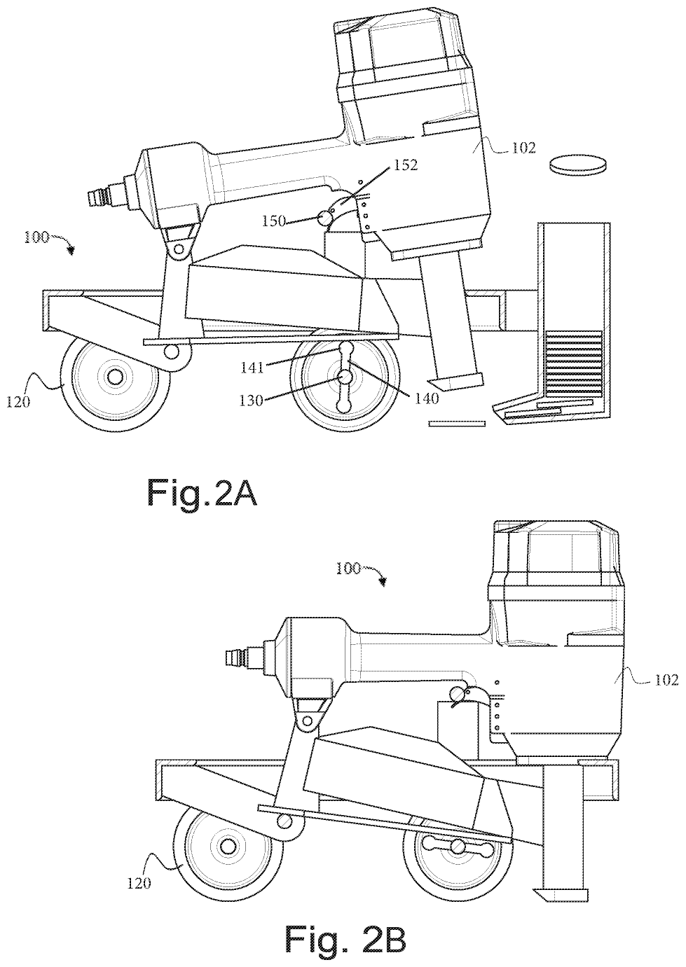

FIG. 2A depicts a right-side view of the wheeled accessory 100 for the nail gun 102 in the down position, according to an example embodiment. FIG. 2A shows that the wheeled accessory 100 includes a cam 140 coupled to a midpoint of the axle 130, the cam having a projection 141 with a height that varies as the axle 130 rotates, wherein the cam 140 is configured to make sliding contact with the nail gun 102 when the nail gun is mounted to the mounting point 135, and wherein the cam 140 lowers the nail gun 102 downwards when the cam is in a second orientation. FIG. 2A shows that the cam 140 is in the second orientation since the cam has lowered the nail gun 102 downwards into the down position.

FIG. 2B depicts a right-side view of the wheeled accessory 100 for the nail gun 102 in the down position, showing certain components in a cross-sectional view, according to an example embodiment. FIG. 2B shows that the wheeled accessory 100 includes a mounting point 135 located at the rear end 114 of the frame 104, the mounting point 135 configured to hingedly couple to the nail gun 102, such that the nail gun rotates about said mounting point. FIG. 2B shows that the nail gun 102 has been lowered downwards into the down position such that the nail gun has rotated about the mounting point such that the working end of the nail gun has been lowered onto the surface of the roof. Once the working end of the nail gun 102 contacts the roof surface, a nail is deployed and driven into the roof surface.

In one embodiment, the mounting point 135 comprises a fulcrum upon which a portion of the nail gun 102 rests, wherein the nail gun rotates about said fulcrum when the nail gun is moved downwards by the cam 140.

FIG. 2B further shows that cam 140 coupled to a midpoint of the axle 130, the cam having a projection 141 with a height that varies as the axle 130 rotates, wherein the cam 140 is configured to make sliding contact with the nail gun 102, and wherein the cam 140 has lowered the nail gun 102 downwards because the cam is in a second orientation. FIG. 2A shows that the cam 140 is in the second orientation since the cam has lowered the nail gun 102 downwards into the down position. In one embodiment, the wheeled accessory 100 may include a handle 171 for pushing the wheeled accessory 100 over the surface of the ground. The handle 171 may comprise a rigid element that connects to the sides (right side and left side) of the frame 104 and extends upwards so that a person may grab the top of the handle with his hands and push the wheeled accessory 100 over the surface of the ground.

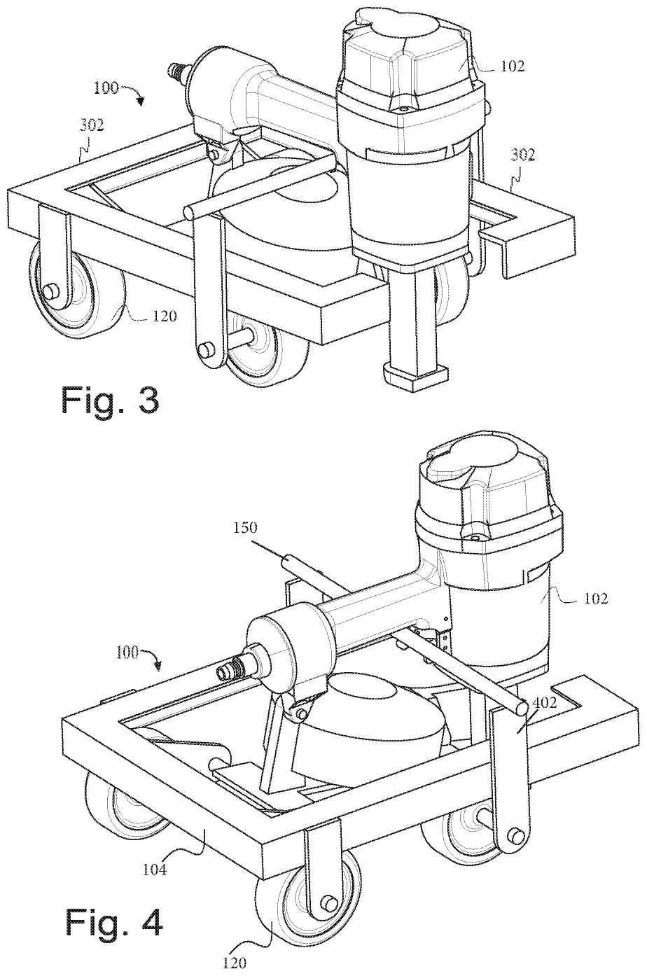

FIG. 3 depicts a right-side perspective view of the wheeled accessory 100 for the nail gun 102 in the down position, according to an example embodiment. FIG. 3 shows that the frame 104 comprises a plurality of structural beams 302 coupled together to form the frame. The structural beams 302 may be secured together at the vertices via welding or equivalent methods known in the art. FIG. 3 also shows that the wheeled accessory 100 for the nail gun 102 comprises four wheels but may alternatively comprise three wheels in a triangular orientation.

FIG. 4 depicts a top perspective view of the wheeled accessory 100 for the nail gun 102 in the down position, according to an example embodiment. FIG. 4 shows that the wheeled accessory 100 includes a rod 150 coupled to a trigger 152 of the nail gun 102, wherein the rod 150 is configured to contact a portion 402 of the frame 104 when the nail gun 102 is lowered downwards, thereby activating the nail gun so as to shoot or deploy a nail into the surface 190. As the wheeled accessory 100 moves forward on the surface 190, the axle 130 rotates the cam 140, which moves the nail gun 102 upwards and subsequently downwards, striking the rod 150 on the frame 104, which results on the nail gun 102 shooting a nail into the surface 190 at periodic intervals.

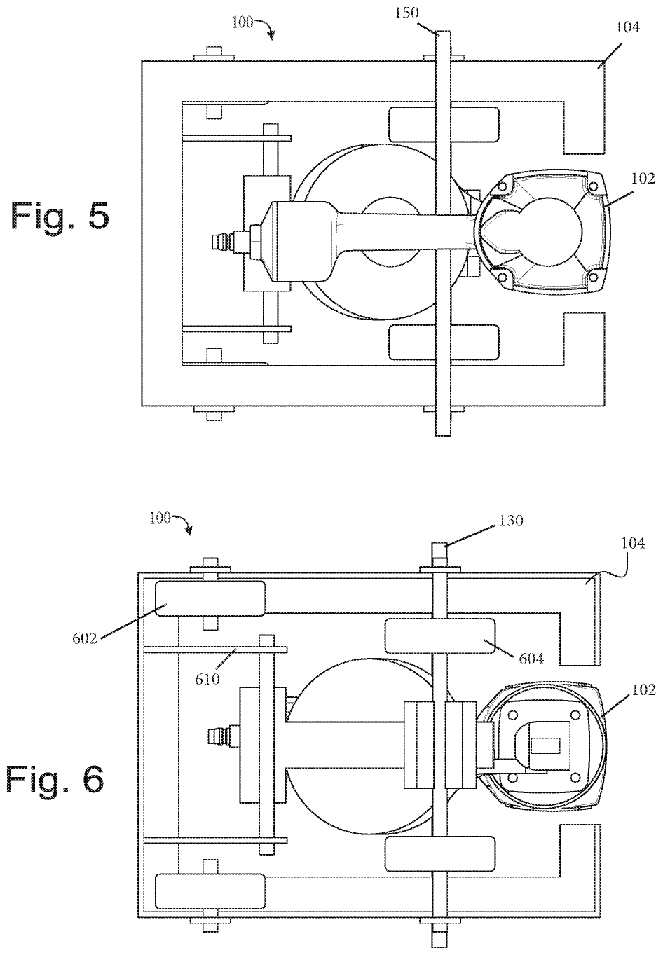

FIG. 5 depicts a top view of the wheeled accessory for the nail gun, according to an example embodiment. FIG. 5 shows that the axle 130 is located near a front end 113 of the frame. FIG. 5 shows that the wheeled accessory 100 includes an axle 130 having wheels 120 at each end of the axle, the axle 130 being coupled to the bottom side 112 of the frame 104.

FIG. 6 depicts a bottom view of the wheeled accessory 100 for the nail gun 102, according to an example embodiment. FIG. 6 shows that the mounting point 135 located at the rear end 114 of the frame 104, the mounting point 135 configured to hingedly couple to the nail gun 102, such that the nail gun rotates about said mounting point. FIG. 6 shows that the mounting point is located between the rear set of wheels 602 and the front set of wheels 604 Once the working end of the nail gun 102 contacts the roof surface, a nail is deployed and driven into the roof surface. FIG. 6 further shows that the mounting point 135 is supported by a pair of flanges 610 that extend from the frame 104.

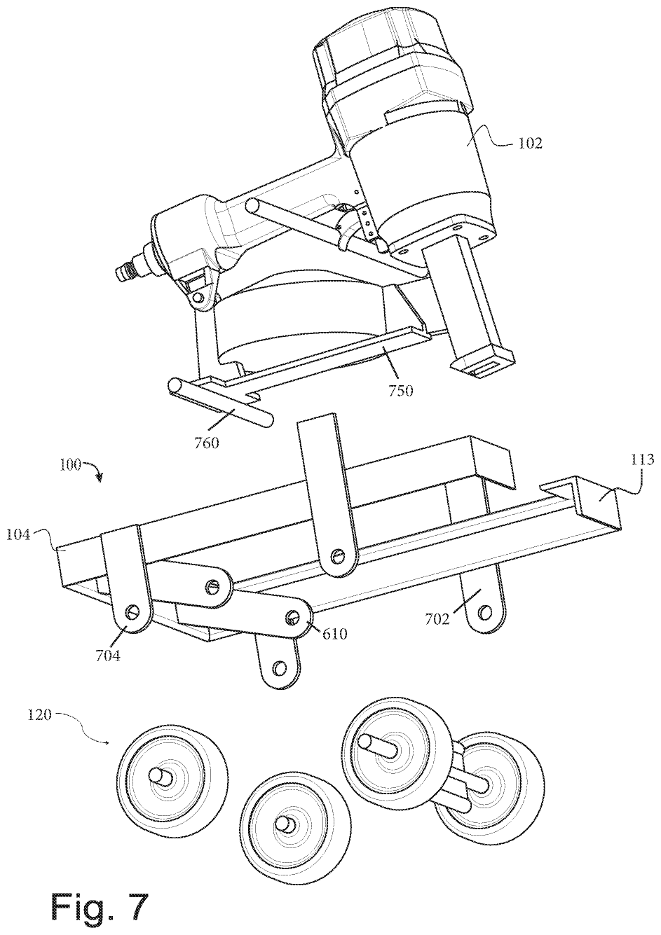

FIG. 7 depicts an exploded view of the wheeled accessory 100 for the nail gun 102, according to an example embodiment. FIG. 7 shows that the wheeled accessory 100 includes a frame 104 having flanges 702 for supporting the axle 130, flanges 704 for supporting the rear wheels, and flanges 610 for supporting the mounting point 135. FIG. 7 further shows that the wheeled accessory 100 includes rear wheels 602 and an axle 130 having wheels 604 at each end of the axle. FIG. 1A further shows that the wheeled accessory 100 includes a mounting point 135 that may include a strike plate 750. The cam 140 is configured to make sliding contact with the strike plate 750, and wherein the cam 140 lifts the nail gun 102 upwards when the cam is in a first orientation and the cam 140 lowers the nail gun 102 downwards when the cam is in a second orientation. FIG. 7 shows that the mounting point 135 may comprise a rod 760 that fits within orifices in the flanges 610 for supporting the mounting point 135.

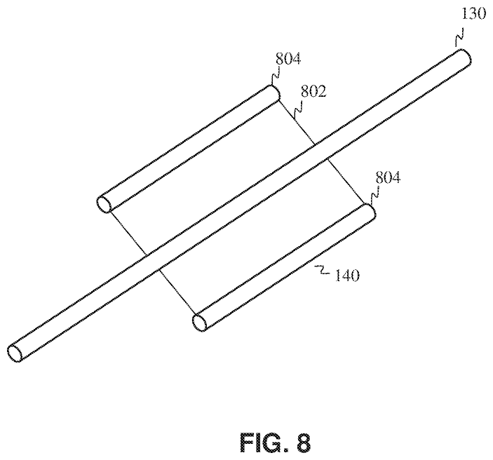

FIG. 8 depicts views of the cam 140 of the wheeled accessory for the nail gun 102, according to an example embodiment. The cam 140 comprises a planar element 802 coupled to the axle 130 such that a longitudinal axis of the axle 130 is parallel to the planar element 802, wherein when the planar element 802 is perpendicular to the surface of the roof, the cam 140 is in the first orientation (see FIG. 1B) and wherein when the planar element 802 is parallel to the surface of the roof, the cam 140 is in the second orientation (see FIG. 2B). The cam 140 comprises rounded or cylindrical elements 804 located at the end of the planar element 802. Recall the mounting point 135 may include a strike plate 750 and the cam 140 is configured to make sliding contact with the strike plate 750, wherein the cam 140 lifts the nail gun 102 upwards when the cam is in a first orientation and the cam 140 lowers the nail gun 102 downwards when the cam is in a second orientation. The rounded sides of the cylindrical elements 804 reduce friction when the cam 140 makes sliding contact with the strike plate 750.

The width of the planar element 802 (calculated outwards from the longitudinal axis of the axle 130) will dictate the interval at which the nail will be deployed by the nail gun 102. The claimed subject matter may also include a set of planar element 802 that can be exchanged to vary the period at which nails are deployed by the nail gun 102.

Embodiments may be described above with reference to functions or acts, which comprise methods. The functions/acts noted above may occur out of the order as shown or described. For example, two functions/acts shown or described in succession may in fact be executed substantially concurrently or the functions/acts may sometimes be executed in the reverse order, depending upon the functionality/acts involved. While certain embodiments have been described, other embodiments may exist. Further, the disclosed methods' functions/acts may be modified in any manner, including by reordering functions/acts and/or inserting or deleting functions/acts, without departing from the spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A wheeled accessory for a nail gun, the accessory comprising:
a frame having a top side, a bottom side, a front and a rear end;
at least three wheels coupled to the bottom of the frame;
an axle having two of the at least three wheels at each end of the axle, the axle being coupled to the bottom of the frame;
a mounting point located at the rear end of the frame, the mounting point configured to hingedly couple to the nail gun, such that the nail gun rotates about said mounting point;
a cam coupled to a midpoint of the axle, the cam having a projection with a height that varies as the axle rotates, wherein the cam is configured to make sliding contact with the nail gun when the nail gun is mounted to the mounting point, and wherein the cam lifts the nail gun upwards when the cam is in a first orientation and the cam lowers the nail gun downwards when the cam is in a second orientation; and
a rod coupled to a trigger of the nail gun, wherein the rod is configured to contact the frame when the nail gun is lowered downwards, thereby activating the nail gun;
wherein when the wheeled accessory moves forward on a surface, the axle rotates the cam, which moves the nail gun upwards and subsequently downwards, and the nail gun shoots a nail into the surface at periodic intervals.

2. The wheeled accessory of claim 1, wherein the frame comprises a plurality of structural beams coupled together.

3. The wheeled accessory of claim 2, wherein the at least three wheels coupled to the bottom of the frame comprises four wheels coupled to the bottom of the frame.

4. The wheeled accessory of claim 3, wherein the axle is located near a front end of the frame.

5. The wheeled accessory of claim 4, wherein the mounting point comprises a fulcrum upon which a portion of the nail gun rests, wherein the nail gun rotates about said fulcrum when the nail gun is moved upwards and subsequently downwards by the cam.

6. The wheeled accessory of claim 5, wherein a cam comprises a planar element coupled to the axle such that a longitudinal axis of the axle is parallel to the planar element, wherein when the planar element is perpendicular to the surface, the cam is in the first orientation and wherein when the planar element is parallel to the surface, the cam is in the second orientation.

7. A wheeled accessory for a nail gun, the accessory comprising:
a frame having a top side, a bottom side, a front and a rear end;
a pair of wheels coupled to the bottom of the rear end of the frame;
a pair of wheels coupled to opposing ends of an axle that is coupled to the bottom of the front end of the frame;
a mounting point located at the rear end of the frame, the mounting point configured to hingedly couple to the nail gun, such that the nail gun rotates about said mounting point;
a cam coupled to a midpoint of the axle, the cam having a projection with a height that varies as the axle rotates, wherein the cam is configured to make sliding contact with the nail gun when the nail gun is mounted to the mounting point, and wherein the cam lifts the nail gun upwards when the cam is in a first orientation and the cam lowers the nail gun downwards when the cam is in a second orientation; and
a rod coupled to a trigger of the nail gun, wherein the rod is configured to contact the frame when the nail gun is lowered downwards, thereby activating the nail gun;
wherein when the wheeled accessory moves forward on a surface, the axle rotates the cam, which moves the nail gun upwards and subsequently downwards, and the nail gun shoots a nail into the surface at periodic intervals.

8. The wheeled accessory of claim 7, wherein the frame comprises a plurality of structural beams coupled together.

9. The wheeled accessory of claim 8, wherein the axle is located near a front end of the frame.

10. The wheeled accessory of claim 9, wherein the mounting point comprises a fulcrum upon which a portion of the nail gun rests, wherein the nail gun rotates about said fulcrum when the nail gun is moved upwards and subsequently downwards by the cam.

11. The wheeled accessory of claim 10, wherein a cam comprises a planar element coupled to the axle such that a longitudinal axis of the axle is parallel to the planar element, wherein when the planar element is perpendicular to the surface, the cam is in the first orientation and wherein when the planar element is parallel to the surface, the cam is in the second orientation.

12. A wheeled accessory for a nail gun, the accessory comprising:
a rectangular frame having a top side, a bottom side, a front and a rear end;
a pair of wheels coupled to the bottom of the rear end of the frame;
a pair of wheels coupled to opposing ends of an axle that is coupled to the bottom of the front end of the frame;
a mounting point located at the rear end of the frame, the mounting point configured to hingedly couple to the nail gun, such that the nail gun rotates about said mounting point;
a cam coupled to a midpoint of the axle, the cam comprising a planar element parallel to a longitudinal axis of the axle, wherein the cam is configured to make sliding contact with the nail gun when the nail gun is mounted to the mounting point, and wherein the cam lifts the nail gun upwards when the cam is in a first orientation and the cam lowers the nail gun downwards when the cam is in a second orientation; and
a rod coupled to a trigger of the nail gun, wherein the rod is configured to contact the frame when the nail gun is lowered downwards, thereby activating the nail gun;
wherein when the wheeled accessory moves forward on a surface, the axle rotates the cam, which moves the nail gun upwards and subsequently downwards, and the nail gun shoots a nail into the surface at periodic intervals.

13. The wheeled accessory of claim 12, wherein the frame comprises a plurality of structural beams coupled together.

14. The wheeled accessory of claim 13, wherein the axle is located near a front end of the frame.

15. The wheeled accessory of claim 14, wherein the mounting point comprises a fulcrum upon which a portion of the nail gun rests, wherein the nail gun rotates about said fulcrum when the nail gun is moved upwards and subsequently downwards by the cam.

16. The wheeled accessory of claim 15, wherein when the planar element is perpendicular to the surface, the cam is in the first orientation and wherein when the planar element is parallel to the surface, the cam is in the second orientation.
